(19) United States
(12) Patent Application Publication
(10) Pub. No.: US 2006/0217935 A1
(43) Pub. Date: Sep. 28, 2006

(54) Vehicle component usage monitor

(75) Inventors: Frederick J. Beiermeister, Farmington Hills, MI (US); Matt C. Videtich, Farmington Hills, MI (US)

Correspondence Address: ANTHONY LUKE SIMON;General Motors Corporation, Legal Staff, 300 Renaissance Center, Mail Code 482-C23-B21, P.O. Box 300, Detroit, MI, 48265-3000, US

(73) Assignee: General Motors Corporation

(21) Appl. No.: 11/091,194

(22) Filed: Mar. 28, 2005

(51) Int. Cl. G06F 11/00

(52) U.S. Cl. 702/188

(57) ABSTRACT

A method, system, and computer readable medium for monitoring component usage at a vehicle, the method including monitoring a usage parameter at a telematics device, incrementing a usage value in a component counter of the telematics device when the usage parameter is detected, and transmitting the usage value to a remote facility.

### RELATED APPLICATIONS

This application is related to U.S. patent application Ser. No. _____, to Oesterling, et al., entitled Method And System For Monitoring And Retrieving Device Usage, filed ______, 2005, and incorporated herein by reference.

### FIELD OF THE INVENTION

The invention relates to vehicles, and more particularly to methods and systems for monitoring vehicle component usage.

### BACKGROUND OF THE INVENTION

Modern vehicles are made of a staggering number of components which run the gamut from the commonplace, such as door hinges, to the complex, such as onboard computers. Components include information and entertainment devices such as conventional radio receivers, satellite radio receivers, cassette tape players, and compact disc (CD) players. Yet, there is no way for the manufacturer of the vehicle or devices to directly determine how and when the customers are using the components, let alone having a way to parse usage data to identify particular usage groups. This lack of usage data hinders maintenance and design decisions.

One example of the problem is estimation of component lifetime for establishing warranty periods and maintenance requirements. Presently, component lifetime estimates are obtained by bench testing of samples or by computer simulation. Warranty periods and maintenance requirements are set from the bench test or simulation results.

Unfortunately, component lifetime estimates often do not reflect component performance in the field. If the warranty period is unrealistically long, the manufacturer may incur great expense in parts and labor to replace components failing under warranty. If the warranty period is unrealistically short, the customer may be disappointed by component failure outside the warranty. If the maintenance requirements are incorrect, the components may fail from insufficient maintenance or the customer may incur unnecessary maintenance with its attendant inconvenience and expense.

Another problem from the lack of usage data is that warranty periods must be based on easily determined parameters, such as time since vehicle purchase or miles traveled. These parameters may not be indicative of the actual use of a particular component. For example, a delivery truck may open and close its doors frequently in making deliveries, much more often than a passenger truck. The hinges in the delivery truck doors would be more likely to fail than the hinges in the passenger truck doors. A warranty based on time or mileage fails to account for the difference in usage.

Yet another problem from the lack of usage data is the lack of actual input for design and marketing. Components may remain part of the vehicle design although they are no longer popular and seldom used. Components may be underused due to poor design, such as man-machine interface problems. Without usage data, these design flaws can persist from one design year to the next.

It would be desirable to have a vehicle component usage monitor that overcomes the above disadvantages.

### SUMMARY OF THE INVENTION

The present invention provides a method for monitoring component usage at a vehicle, the method including monitoring a usage parameter at a telematics device, incrementing a usage value in a component counter of the telematics device when the usage parameter is detected, and transmitting the usage value to a remote facility.

Another aspect of the invention provides a system for monitoring component usage at a vehicle, the system including means for monitoring a usage parameter at a telematics device, means for incrementing a usage value in a component counter of the telematics device when the usage parameter is detected, and means for transmitting the usage value to a remote facility.

Yet another aspect of the invention provides a computer readable medium for monitoring component usage at a vehicle, the computer readable medium including computer readable code for monitoring a usage parameter at a telematics device, computer readable code for incrementing a usage value in a component counter of the telematics device when the usage parameter is detected, and computer readable code for transmitting the usage value to a remote facility.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustrative operating environment for monitoring component usage at a vehicle in accordance with one embodiment of the present invention;

FIG. 2 is a flow diagram of a method for monitoring component usage at a vehicle in accordance with one embodiment of the present invention; and

FIG. 3 is a schematic diagram of an example usage parameter in accordance with the present invention.

### DETAILED DESCRIPTION OF THE PRESENTLY PREFERRED EMBODIMENT

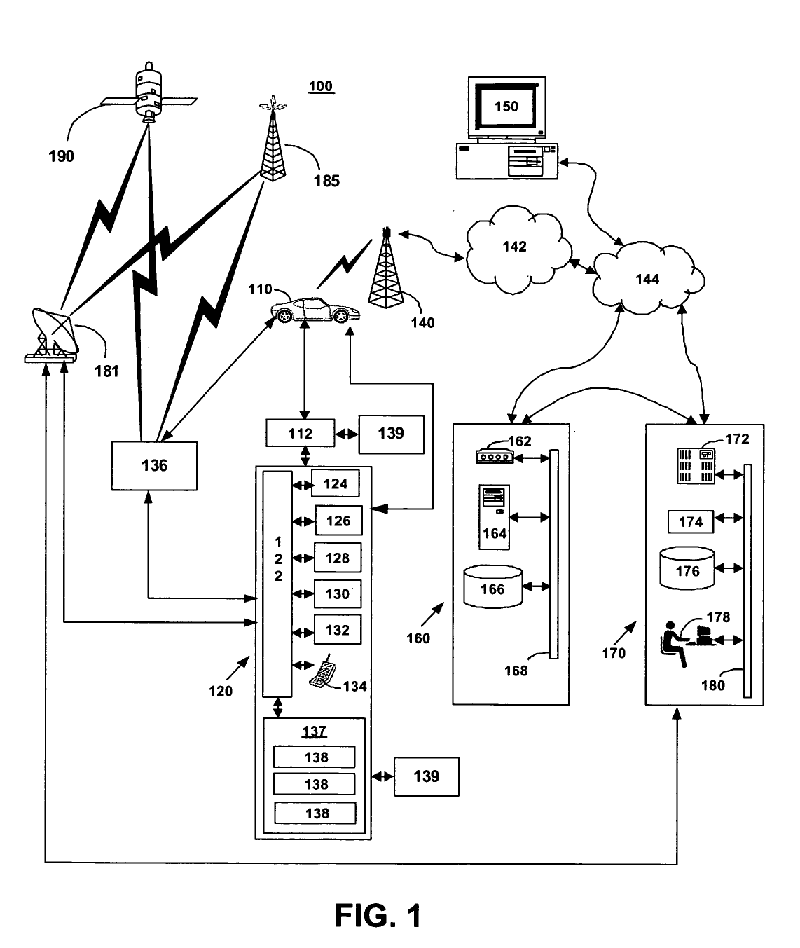

FIG. 1 is an illustrative operating environment for monitoring component usage at a vehicle in accordance with one embodiment of the present invention. FIG. 1 shows a mobile vehicle communication system 100. System 100 includes at least one mobile vehicle 110 (vehicle) including vehicle communication network 112 and telematics device 120; a satellite radio receiver system 136; one or more wireless carrier systems 140; one or more communication networks 142; one or more land networks 144; one or more client, personal, or user computers 150; one or more web-hosting portals 160; one or more call centers 170; one or more satellite radio service uplink facilities 181; one or more terrestrial radio transmitters 185; and one or more satellite radio service geostationary satellites 190. In one embodiment, mobile vehicle 110 is implemented as a vehicle equipped with suitable hardware and software for transmitting and receiving voice and data communications. The telematics device 120 is also called a vehicle communications unit (VCU) or a telematics unit. The telematics device 120 is operably connected to vehicle components 139 directly and/or through the vehicle communication network 112.

In one embodiment, the telematics device 120 includes a processor 122 connected to a wireless modem 124, a global positioning system (GPS) unit 126, an in-vehicle memory 128 such as, for example, a non-volatile flash memory or a hard drive, a microphone 130, one or more speakers 132, an embedded or in-vehicle mobile phone 134, and a component monitor 137 including one or more component counters 138. In one embodiment, processor 122 is a microcontroller, controller, host processor, or vehicle communications processor. In an example, processor 122 is implemented as an application specific integrated circuit (ASIC). GPS unit 126 provides longitude and latitude coordinates of the vehicle, as well as a time and date stamp. In one embodiment, at least part of the in-vehicle memory 128 is removable for use outside the vehicle 110. In-vehicle mobile telephone system 134 is a cellular-type phone such as, for example, an analog, digital, dual-mode, dual-band, multi-mode, or multi-band cellular phone. In another example, the mobile telephone system is an analog mobile telephone system operating over a prescribed band nominally at 800 MHz. In yet another example, the mobile telephone system is a digital mobile telephone system operating over a prescribed band nominally at 800 MHz, 900 MHz, 1900 MHz, or any suitable band capable of carrying digital cellular communications. The components of the telematics device 120 can be distributed throughout the vehicle and need not be mounted within a single enclosure.

Processor 122 executes various computer programs and communication control and protocol algorithms that affect communication, programming, and operational modes of electronic and mechanical systems within vehicle 110. In one embodiment, processor 122 is an embedded system controller. In another embodiment, processor 122 controls communications between telematics device 120, wireless carrier system 140, call center 170, terrestrial radio transmitter 185, and satellite radio geostationary satellite 190. In yet another embodiment, processor 122 controls communications between the wireless modem 124 and nodes of a mobile ad hoc network. In still another embodiment, processor 122 provides processing, analysis, and control functions for determining engine emission performance for vehicle 110. Processor 122 is configured to generate and receive digital signals transmitted between telematics device 120 and a vehicle communication network 112 that is connected to various electronic modules in the vehicle 110. In one embodiment, the digital signals activate a programming mode and operation modes, as well as provide for data transfers. In another embodiment, a utility program facilitates the transfer of emission data, emission analysis data, instructions, triggers, and data requests between vehicle 110 and a call center 170.

Mobile vehicle 110, via a vehicle communication network 112, sends signals to various units of equipment and systems within vehicle 110 to perform various functions such as monitoring the operational state of vehicle systems, collecting and storing data from the vehicle systems, providing instructions, data and programs to various vehicle systems, and calling from telematics device 120. In facilitating interactions among the various communication and electronic modules, vehicle communication network 112 utilizes interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Vehicle 110, via telematics device 120, sends and receives radio transmissions from wireless carrier system 140. Wireless carrier system 140 is implemented as any suitable system for transmitting a signal from mobile vehicle 110 to communication network 142. Wireless carrier system 140 incorporates any type of telecommunications in which electromagnetic waves carry signal over part of or the entire communication path. In one embodiment, wireless carrier system 140 transmits analog audio and/or video signals. In an example, wireless carrier system 140 transmits analog audio and/or video signals such as those sent from AM and FM radio stations and transmitters, or digital audio signals in the S band (approved for use in the U.S.) and L band (used in Europe and Canada). In one embodiment, wireless carrier system 140 is a satellite broadcast system broadcasting over a spectrum in the S band (2.3 GHz) that has been allocated by the U.S. Federal Communications Commission (FCC) for nationwide broadcasting of satellite-based Digital Audio Radio Service (DARS).

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144. In one example, wireless carrier system 140 includes a short message service, modeled after established protocols such as IS-637 SMS standards, IS-136 air interface standards for SMS, and GSM 03.40 and 09.02 standards. Similar to paging, an SMS communication could be broadcast to a number of regional recipients. In another example, the carrier system 140 uses services in accordance with other standards such as, for example, IEEE 802.11 compliant wireless systems and Bluetooth compliant wireless systems.

Land network 144 is a public-switched telephone network (PSTN). In one embodiment, land network 144 is implemented as an Internet protocol (IP) network. In other embodiments, land network 144 is implemented as a wired network, an optical network, a fiber network, another wireless network, a virtual private network (VPN), or any combination thereof. Land network 144 is connected to one or more landline telephones. Land network 144 connects communication network 142 to computer 150, web-hosting portal 160, and call center 170. Communication network 142 and land network 144 connect wireless carrier system 140 to web-hosting portal 160 and call center 170.

Client, personal, or user computer 150 includes a computer usable medium to execute Internet-browser and Internet-access computer programs for sending and receiving data over land network 144 and, optionally, wired or wireless communication networks 142 to web-hosting portal 160 and vehicle 110. Computer 150 sends data to web-hosting portal 160 through a web-page interface using communication standards such as hypertext transport protocol (HTTP) and transport-control protocol Internet protocol (TCP/IP). In one embodiment, the data includes directives to change certain programming and operational modes of electronic and mechanical systems within vehicle 110. In another embodiment, the data includes requests for certain data, such as vehicle system performance information. In operation, a user, such as, for example, a vehicle designer or manufacturing engineer, utilizes computer 150 to exchange information with mobile vehicle 110 that is cached or stored in web-hosting portal 160. In an embodiment, vehicle system performance information from client-side software is transmitted to server-side software of web-hosting portal 160. In one embodiment, vehicle system performance information is stored at web-hosting portal 160. In another embodiment, computer 150 includes a database (not shown) for storing received vehicle system performance data. In yet another embodiment, a private Local Area Network (LAN) is implemented for client computer 150 and web-hosting portal 160, such that web-hosting portal is operated as a Virtual Private Network (VPN).

Web-hosting portal 160 includes one or more data modems 162, one or more web servers 164, one or more databases 166, and a network 168. Web-hosting portal 160 is connected directly by wire to call center 170, or connected by phone lines to land network 144, which is connected to call center 170. Web-hosting portal 160 is connected to land network 144 by one or more data modems 162. Land network 144 transmits digital data to and from modem 162, data that is subsequently transferred to web server 164. In one implementation, modem 162 resides inside web server 164. Land network 144 transmits data communications between web-hosting portal 160 and call center 170.

Web server 164 receives various data, requests, or instructions from computer 150 via land network 144. In alternative embodiments, computer 150 includes a wireless modem to send data to web-hosting portal 160 through a wireless communication network 142 and a land network 144. Data is received by modem 162 and sent to one or more web servers 164. In one embodiment, web server 164 is implemented as any suitable hardware and software capable of providing web services to transmit and receive data from computer 150 to telematics device 120 in vehicle 110. Web server 164 sends to or receives data transmissions from one or more databases 166 via network 168. In an embodiment, web server 164 includes computer applications and files for managing emission performance data.

In one embodiment, one or more web servers 164 are networked via network 168 to distribute vehicle engine emission performance data among its network components such as database 166. In an example, database 166 is a part of or a separate computer from web server 164. In one embodiment, web-server 164 sends data transmissions including vehicle system performance information to call center 170 via modem 162, and through land network 144.

Call center 170 is a location where many calls are received and serviced at the same time, or where many calls are sent at the same time. In one embodiment, the call center is a telematics call center, facilitating communications to and from telematics device 120 in vehicle 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more networks 180.

Switch 172 of call center 170 connects to land network 144. Switch 172 transmits voice or data transmissions from call center 170, and receives voice or data transmissions from telematics device 120 in mobile vehicle 110 through wireless carrier system 140 and/or wireless modem 124, communication network 142, and land network 144. Switch 172 receives data transmissions from and sends data transmissions to one or more web-hosting portals 160. Switch 172 receives data transmissions from or sends data transmissions to one or more communication services managers 174 via one or more networks 180.

Communication services manager 174 is any suitable hardware and software capable of providing communication services to telematics device 120 in mobile vehicle 110. Communication services manager 174 sends to or receives data transmissions from one or more communication services databases 176 via network 180. Communication services manager 174 sends to or receives data transmissions from one or more communication services advisors 178 via network 180. Communication services database 176 sends to or receives data transmissions from communication services advisor 178 via network 180. Communication services advisor 178 receives from or sends voice or data transmissions to switch 172.

Communication services manager 174 facilitates one or more services, such as, but not limited to, enrollment services, navigation assistance, directory assistance, roadside assistance, business or residential assistance, information services assistance, emergency assistance, communications assistance, and telematics retrieval of vehicle system performance information. Communication services manager 174 transmits and receives operational status, instructions, and other types of vehicle data to telematics device 120 in mobile vehicle 110 through wireless carrier system 140, communication network 142, land network 144, wireless modem 124, voice and data switch 172, and network 180. Communication services manager 174 stores or retrieves vehicle system performance information from communication services database 176. Communication services manager 174 provides requested information to communication services advisor 178.

In one embodiment, communication services advisor 178 is a real advisor. In another embodiment, communication services advisor 178 is implemented as a virtual advisor. In an example, a real advisor is a human being at a service provider service center in verbal communication with a service subscriber in mobile vehicle 110 via telematics device 120. In another example, a virtual advisor is implemented as a synthesized voice interface responding to requests from telematics device 120 in mobile vehicle 110.

Communication services advisor 178 provides services to telematics device 120 in mobile vehicle 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics device 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 initiates service requests to call center 170 by sending a voice or digital-signal command to telematics device 120, which, in turn, sends an instructional signal or a voice call through wireless modem 124, wireless carrier system 140, communication network 142, and land network 144 to call center 170. In one embodiment, one or more triggers stored in the telematics device 120 cause the vehicle to initiate a service request. The trigger is, for example, a number of ignition cycles, a specific time and date, an expired time, a number of kilometers, an absolute Global Positioning System (GPS) timestamp, a request for vehicle emission performance data, and the like.

A Satellite Based Digital Radio Service System (SDARS) provides radio programming from geostationary satellite 190 to vehicle 110. The SDARS system includes a satellite radio uplink facility 181 in communication with the telematics service call center 170 that sends radio signals to the geostationary satellite 190. The geostationary satellite 190 transmits radio signals to satellite radio receiver system 136 in vehicle 110. In one embodiment, the terrestrial radio transmitter 185 transmits radio signals to satellite radio receiver system 136 in vehicle 110. The terrestrial radio transmitter 185 can carry out the same functions as the geostationary satellite 190 when the vehicle 110 is within range of the terrestrial radio transmitter 185. Those skilled in the art will appreciate that the SDARS can be used to transmit any digital information, such as audio and/or video programming.

In one embodiment, the terrestrial radio transmitter 185 and geostationary satellite 190 broadcast over a spectrum in the S band (2.3 GHz) that has been allocated by the U.S. Federal Communications Commission (FCC) for nationwide broadcasting of Satellite Based Digital Radio Service (SDARS). An exemplary broadcast has a 120 kilobyte per second portion of the bandwidth designated for command signals from the telematics service call center 170.

The SDARS system broadcasts music and entertainment, traffic information, road construction information, advertisements, news, local event information, or the like. The SDARS system can also transmit information about the program being broadcast. In one embodiment, the information includes the names of the program and program artist. For example, if the program is a song, the information can include the name of the song and the artist.

In one embodiment, the satellite radio receiver system 136 is separate from the telematics device 120. In an alternative embodiment, the satellite radio receiver system 136 is electronically connected to the telematics device 120 with a cable or over the vehicle communication bus. In another embodiment, the satellite radio receiver system 136 is embedded within the telematics device 120. In one embodiment, the satellite radio receiver system 136 provides channel and signal information to the telematics device 120. The telematics device 120 monitors, filters and sends signals that are received from satellite broadcast, radio broadcasts or other wireless communication systems to output devices, such as the speaker 132 and visual display devices. In another embodiment, the signals from the satellite radio receiver system 136 are sent directly to independent output devices, such as speakers and visual display devices, without the intervening telematics device 120.

The component monitor 137 in the telematics device 120 monitors usage parameters of vehicle components 139 operably connected to the telematics device 120 directly and/or through the vehicle communication network 112. Component counters 138 in the component monitor 137 increment usage values for their respective vehicle components 139 when the usage parameters are detected. The component counters 138 store the usage values until the usage values are transmitted to a remote facility, such as one or more web-hosting portals 160 or one or more call centers 170 over the mobile vehicle communication system 100. In an alternate embodiment, the component monitor 137 can be external to the component monitor 137 and the telematics device 120.

The component monitor 137 with the component counters 138 can be implemented in software in the telematics device 120. In an alternative embodiment, the component monitor 137 with the component counters 138 can be implemented as hardware.

The vehicle components 139 can be any vehicle component in communication with the telematics device 120. The telematics device 120 monitors the vehicle components 139 for usage parameters, such as whether a particular vehicle component is off or on, open or closed. In one embodiment, the vehicle components 139 communicate with the telematics device 120 through the vehicle communication network 112. In an alternate embodiment, the vehicle components 139 communicate with the telematics device 120 directly. The vehicle components 139 can be electrical or electronic components, such as information and entertainment devices, conventional radio receivers, satellite radio receiver systems, cassette tape players, compact disc (CD) players, onboard computers, or the like. One example of an electronic component is the satellite radio receiver system 136. The usage parameter for an electrical or electronic component is typically whether the component is powered on or off. The vehicle components 139 can also be mechanical devices, such as door hinges, trunk hinges, door latches, or the like, fitted with suitable sensors to provide direct indication or providing indirect indication to the telematics device 120. One example of direct indication is a limit switch installed between the leaves of a hinge to indicate open or closed. One example of indirect indication is an activation signal to release a trunk latch, indicating cycling of the trunk hinges. The usage parameter for a mechanical component is typically whether the component is in a particular state or position. Those skilled in the art will appreciate that any number of vehicle components 139 of various types can be in communication with the telematics device 120 to provide usage parameters to the telematics device 120.

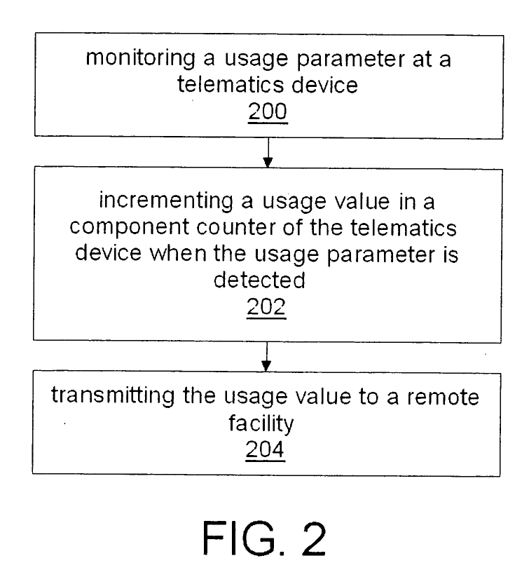

FIG. 2 is a flow diagram of a method for monitoring component usage at a vehicle in accordance with one embodiment of the present invention. The method includes monitoring a usage parameter at a telematics device 200, incrementing a usage value in a component counter when the usage parameter is detected 202, and transmitting the usage value to a remote facility 204. In one embodiment, the usage value is used to determine when a component in the vehicle reaches a component limit. In another embodiment, group usage values are compiled for a plurality of vehicles and used to determine a component characteristic. The method operates within an environment and using a system such as the exemplary system of FIG. 1. The method is embodied in a computer usable medium for monitoring component usage including computer readable code for executing the method described by FIG. 2.

Monitoring a usage parameter at a telematics device 200 includes monitoring a usage parameter for a component directly or indirectly through monitoring vehicle bus messages on a vehicle communication network. The monitoring can be performed using a component monitor within the telematics device. The usage parameter is any usage parameter indicating component operation or cycling, such as a command to the component, power to the component, sensor indication from the component, or the like. The monitoring can include monitoring a plurality of usage parameters for a plurality of components.

Incrementing a usage value in a component counter when the usage parameter is detected 202 includes incrementing a usage value in a component counter which is internal or external to the telematics device. The usage value can be time, recording the duration of time when the component is in use, or can be events, recording the number of times the component is actuated, or can be cycles, recording the number of times the component is cycled. The incrementing can include incrementing a plurality of usage values in a plurality of component counters when a plurality of components is monitored.

Transmitting the usage value to a remote facility 204 includes transmitting the usage value from the telematics device to a remote facility, such as a call center or a web-hosting portal, over the mobile vehicle communication system. In one embodiment, the transmitting the usage value is performed at a predetermined interval, such as hourly, daily, monthly, annually, or the like. Transmitting at a predetermined interval allows the usage value data to be analyzed as a function of time. For example, transmitting the usage value monthly would allow analysis as to whether a particular component is used more in a particular season. The transmitting can include transmitting a plurality of usage values from a plurality of component counters when a plurality of components is monitored.

The usage value can be stored, analyzed, and processed at the remote facility. In one embodiment, the usage value is used to determine when a component in the vehicle reaches a component limit. In another embodiment, group usage values are compiled for a plurality of vehicles and used to determine a component characteristic.

Determining when a component in the vehicle reaches a component limit based on the usage value includes determining when a component reaches a component limit such as a warranty limit, a maintenance limit, or the like. The component limit is based on the actual history of the particular component as indicated by the usage value received at the remote facility. In one embodiment, the driver is notified from the call center or another remote location when the component limit has been reached. For example, the maintenance limit or warranty limit for a door hinge can be reached when the usage value indicates a certain number of cycles of the hinge. The call center can notify the driver through the telematics device that the door hinge has reached the number of cycles for the maintenance limit and offer to make a service appointment. For the warranty limit, the call center can offer additional warranty coverage when making the notification.

Compiling group usage values for a plurality of vehicles and determining a component characteristic from the group usage values includes compiling the usage values received at the remote facility for a plurality of vehicles into group usage values and analyzing the group usage values to determine a component characteristic. The component characteristic is any information that can be determined about a component by analyzing the group usage values, i.e., the usage values for a population of vehicles. Examples of component characteristics include expected component lifetime, typical component maintenance, typical component usage, and typical component usage patterns. The analysis can also draw on other available information, such as available information about individual vehicle owners or groups of vehicle owners. The population of vehicles can also be selected as a limited population of interest, such as vehicles of a particular make, model year, body style, or any other particular classification. For example, the group usage values could be compiled for 2005 Chevrolet trucks and the component characteristic of monthly door hinge usage could be determined from the group usage values.

Component limits can be set based on the component characteristics. Time, cycle, or event maintenance limits for a particular component can be based on expected component lifetime and/or typical component maintenance. For example, the maintenance interval for greasing of door hinges can be relaxed if the door hinges are lasting longer than expected. Component functionality limits, i.e., whether the ergonomics of a component requires redesign, can be based on typical component usage, such as whether a component is underused. For example, redesign of a particular model of satellite radio may be required if the particular model is used less than typical satellite radios. Component demand limits, i.e., whether the popularity of a component warrants continued inclusion of the component in a vehicle, can be based on typical component usage patterns, such as whether component usage is declining. For example, cassette tape players may be in declining use as other audio formats become popular, so that cassette tape players should no longer be installed in the vehicle.

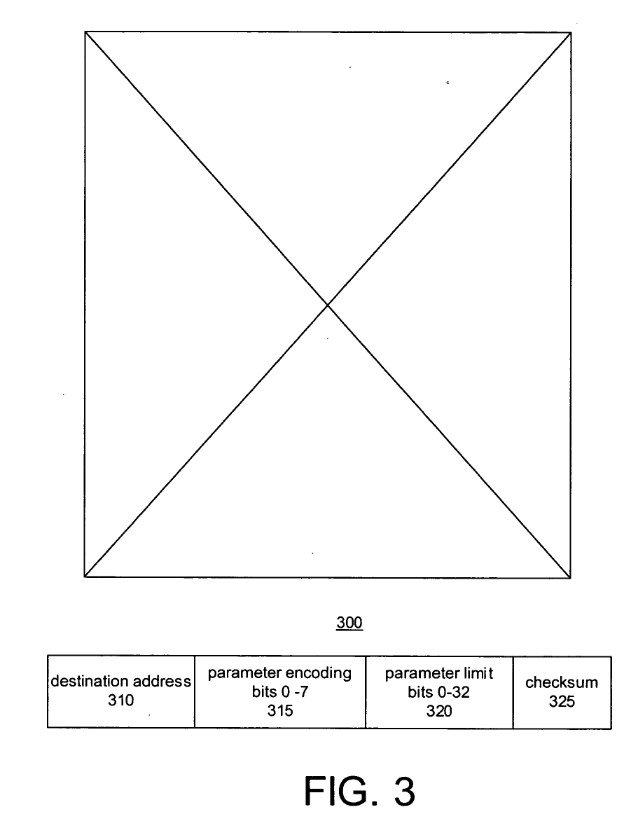

FIG. 3 is a schematic diagram of an example usage parameter in accordance with the present invention at 300. A destination address 310 may contain a vehicle identification number (VIN) encoded with 17 alphanumeric characters, with eight bits (binary digits) per character. The destination address identifies a specific vehicle the usage parameter is intended for. Parameter encoding 315 bits zero through seven indicate which vehicle components (FIG. 1, 138) to monitor. In one embodiment, each bit position may be predetermined to correspond to a specific vehicle component. For example, a one set in bit position zero may indicate that brake pedal depressions are to be monitored, and a one set in bit position three may indicate that trunk hinge cycles are to be monitored. In other embodiments the parameter encoding 315 bit length may be sixteen, thirty two, sixty four or greater bit lengths to accommodate the number of vehicle components to monitor.

Parameter limit 320 field encodes the time duration requested to monitor the vehicle components (FIG. 1, 138) selected in the parameter encoding 315 field. In one embodiment parameter limit 320 bits zero through thirty two represent an unsigned long integer to be used to represent a time duration for monitoring a plurality of vehicle components (FIG.1, 138). Long integers are commonly used by practitioners in the art for encoding time values. In other embodiments, multiple parameter limit fields may be used to encode monitoring start and end times, where the end time minus the start time yields a monitor duration period.

A checksum field 325 may be appended to the parameter limit 320 field to provide a basis for testing the integrity of the usage parameter message when received by the telematics unit (FIG. 1, 120). In one embodiment the checksum may be calculated by a cyclic redundancy check (CRC), as known in the art. In another embodiment, the checksum may be calculated by an exclusive-or (XOR) algorithm, also well known in the art,

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

We claim:

1. A method for monitoring component usage at a vehicle, the method comprising:
monitoring a usage parameter at a telematics device;
incrementing a usage value in a component counter of the telematics device when the usage parameter is detected; and
transmitting the usage value to a remote facility.

2. The method of claim 1 wherein the usage value is selected from the group consisting of time, cycles, and events.

3. The method of claim 1 wherein the monitoring comprises monitoring vehicle bus messages on a vehicle communication network.

4. The method of claim 1 wherein the transmitting comprises transmitting the usage value at a predetermined interval.

5. The method of claim 1 further comprising determining when a component in the vehicle reaches a component limit based on the usage value.

6. The method of claim 5 wherein the component limit is selected from the group consisting of a warranty limit and a maintenance limit.

7. The method of claim 5 further comprising notifying a driver when the component limit has been reached.

8. The method of claim 1 further comprising:
compiling group usage values for a plurality of vehicles; and
determining a component characteristic from the group usage values.

9. The method of claim 8 wherein the component characteristic is selected from the group consisting of expected component lifetime, typical component maintenance, typical component usage, and typical component usage patterns.

10. The method of claim 8 further comprising setting a component limit based on the component characteristic.

11. A system for monitoring component usage at a vehicle, the system comprising:
means for monitoring a usage parameter at a telematics device;
means for incrementing a usage value in a component counter of the telematics device when the usage parameter is detected; and
means for transmitting the usage value to a remote facility.

12. The system of claim 11 wherein the usage value is selected from the group consisting of time, cycles, and events.

13. The system of claim 11 wherein the means for monitoring comprises means for monitoring vehicle bus messages on a vehicle communication network.

14. The system of claim 11 wherein the means for transmitting comprises means for transmitting the usage value at a predetermined interval.

15. The system of claim 11 further comprising means for determining when a component in the vehicle reaches a component limit based on the usage value.

16. The system of claim 15 further comprising means for notifying a driver when the component limit has been reached.

17. The system of claim 11 further comprising:
means for compiling group usage values for a plurality of vehicles; and
means for determining a component characteristic from the group usage values.

18. The system of claim 17 further comprising means for setting a component limit based on the component characteristic.

19. A computer readable medium for monitoring component usage at a vehicle, the computer readable medium comprising:
computer readable code for monitoring a usage parameter at a telematics device;
computer readable code for incrementing a usage value in a component counter of the telematics device when the usage parameter is detected; and
computer readable code for transmitting the usage value to a remote facility.

20. The computer readable medium of claim 19 wherein the usage value is selected from the group consisting of time, cycles, and events.

21. The computer readable medium of claim 19 wherein the computer readable code for monitoring comprises computer readable code for monitoring vehicle bus messages on a vehicle communication network.

22. The computer readable medium of claim 19 wherein the computer readable code for transmitting comprises computer readable code for transmitting the usage value at a predetermined interval.

23. The computer readable medium of claim 19 further comprising computer readable code for determining when a component in the vehicle reaches a component limit based on the usage value.

24. The computer readable medium of claim 23 further comprising computer readable code for notifying a driver when the component limit has been reached.

25. The computer readable medium of claim 19 further comprising:
computer readable code for compiling group usage values for a plurality of vehicles; and
computer readable code for determining a component characteristic from the group usage values.

26. The computer readable medium of claim 25 further comprising computer readable code for setting a component limit based on the component characteristic.
